(19) United States
(12) Patent Application Publication
(10) Pub. No.: US 2003/0068214 A1
(43) Pub. Date: Apr. 10, 2003

(54) Detachable close-tolerance connection unit including a fitting screw and a supporting ring

(76) Inventors: Wolfgang Sommer, Gemunden (DE); Uwe Wittich, Kirtorf (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/264,683

(22) Filed: Oct. 4, 2002

(30) Foreign Application Priority Data
Oct. 4, 2001 (DE) 101 49 017.8-12

(51) Int. Cl. F16B 43/00

(52) U.S. Cl. 411/533

(57) ABSTRACT

A detachable close-tolerance connection unit for a component includes a fitting screw including a head, a shank, a threaded portion and a fitting portion. The shank includes a rim element. A supporting ring includes an opening and a narrowing element being located in the opening. The inner diameter of the narrowing element is less than the outer diameter of the rim element. The supporting ring is connectable to the fitting screw with elastic-plastic deformation to reach a pre-assembled position. The narrowing element in the pre-assembled position is located in a portion of the opening facing the head of the fitting screw. The narrowing element in the pre-assembled position is associated with the rim element such that the supporting ring is rotatably and captively connected to the fitting screw. The rim element in the pre-assembled position is located inside of the opening.

### CROSS REFERENCE TO RELATED APPLICATIONS

This application claims priority to co-pending German Patent Application No. 101 49 017.8 entitled “Lösbares Verbindungselement für ein Bauteil, mit einer Schraube und einem Stützring”, filed Oct. 4, 2001.

### FIELD OF THE INVENTION

The present invention generally relates to a detachable close-tolerance connection unit for a component. More particularly, the present invention relates to a close-tolerance connection unit including a fitting screw having a head and a shank including a threaded portion and a fitting portion. Furthermore, the connection unit includes a supporting ring having an opening.

The novel connection unit may be used to fix components, for example components in the automobile industry. The supporting ring is being connected to the fitting screw in a pre-assembly step. The connection unit may be designed in a way that the supporting ring may be turned or rotated with respect to the fitting screw, and that the supporting ring and the fitting screw may be moved with respect to one another in a radial direction. However, this movement is to be understood as only a small movement as it, for example, makes sense to compensate dividing errors of a wheel dish and/or of a hub. The detachable close-tolerance connection unit for a component may also be used for other purposes.

### BACKGROUND OF THE INVENTION

It is generally known in the art to use fitting screws including a fitting portion and a threaded portion in combination with loose supporting rings. These loose supporting rings may be designed as plain washers. Before screwing the fitting screw into the component, the supporting ring is pushed along the shank of the screw. Consequently, two elements—meaning the screw and the loose supporting ring—have to be handled during assembly, and they have to be pre-assembled directly before assembly. Such a procedure is difficult, expensive and insecure especially during machine assembly.

A detachable connection unit including a screw and a supporting ring is known from Gennan “Gebrauchsmuster” 298 19 782 U1 corresponding to European Patent Application 1 126 982 A1 and International Application PCT/EP99/08174 which has been published as WO 00/27653. The shank of the known screw includes a rim protruding in a radial outward direction and a threaded portion being located at the free end of the shank. The rim is connected close to the end of the threaded portion with a respective transition portion. The axial distance between the rim and the supporting surface of the head is more than the axial height of the supporting ring. The diameter of the rim is more than the diameter of the shank. The supporting ring includes an opening. The supporting ring includes a narrowing being located at the end of the opening facing away from the head of the screw. The diameter of the narrowing is more than the diameter of the shank and of the outer diameter of the threaded portion. The supporting ring is designed to be elastically expandable in the region of its diameter. The rim being located at the shank of the screw is visible after pre-assembly of the elements. It is located at a place which makes it impossible to use this place to fulfill a special function, for example a fitting function by arranging a fitting portion. Consequently, the known unit cannot be used for a fitting screw.

A detachable connection element for a component is also known from German Patent No. 37 84 325 T2 corresponding to European Patent No. 0 272 642 B1 and to U.S. Pat. No. 4,732,519. The known unit includes three elements, namely a screw, a bush and a form part being made of rubber or a different elastic material. The bush includes a cylindrical portion extending in an axial direction and a collar facing the head of the screw. A narrowing is formed in the region of the collar, the narrowing extending to be continuous about 360°. The shank of the known screw includes a cylindrical shank portion close to the head and a threaded portion close to the free end of the screw. A plurality of radial protrusions or wings are located in a manner distributed about the circumference. There is an overlap between the protrusions being located at the screw and the narrowing being located at the bush. The screw and the bush are pre-assembled under elastic expansion such that the narrowing being located at the bush snaps over the protrusions and the wings, respectively, being located at the shank of the screw. The protrusions or the wings do not allow for an arrangement of a fitting portion.

Another detachable connection unit in the form of a wheel bolt is known from European Patent No. 0 836 016 B1 corresponding to U.S. Pat. No. 6,106,077. The wheel bolt includes a head and a shank including a threaded portion. The screw at its shank includes a rim protruding radially in an outward direction and extending over 360°. The rim is located between a cylindrical portion of the shank and a threaded portion being located at the free end of the shank. The supporting ring includes an opening the diameter of which is more than the outer diameter of the threaded portion and also more than the diameter of the rim. During pre-assembly, the supporting ring is pushed over the screw in an axial direction, and it is plastically deformed by calking. In this way, the supporting ring is supported at the wheel bolt to be rotatable and captive. Usually, four calks are used in a spaced apart manner above the circumference. The rim of the screw in the mounted position of the connection element at the component is located outside of the portion of the supporting ring such that this portion of the shank cannot be used to fulfill other functions. Calking is an additional process step.

A fastener unit for clamping plastic work pieces at comparatively thin components is known from German Patent Application No. 30 00 697 A1 corresponding to U.S. Pat. No. 4,238,165. The unit includes a tapping fastener element including a shank. The tapping element includes threads cutting a thread in the component. A distance piece serves to fix the plastic material and to transmit the axial force onto the component. The height of the distance piece is coordinated with the thickness of the plastic material. The distance piece protrudes through a hole being located in the plastic material, and it includes a narrowing being located in an opening and facing the head of the tapping screw. The shank of the tapping screw close to the threaded portion includes a protruding continuous rim being associated with the narrowing. In the mounted position, the threads of the tapping screw extend into the opening of the distance piece in an axial direction such that there is no possibility of arranging a fitting portion. However, such tapping screws are only used for connections of comparatively low quality in which there are no fitting portions.

### SUMMARY OF THE INVENTION

The present invention relates to a detachable close-tolerance connection unit for a component. The detachable close-tolerance connection unit includes a fitting screw including a head, a shank, a threaded portion and a fitting portion. The shank includes a rim element. A supporting ring includes an opening and a narrowing element being located in the opening. The inner diameter of the narrowing element is less than the outer diameter of the rim element. The supporting ring is connectable to the fitting screw with elastic-plastic deformation to reach a pre-assembled position. The narrowing element in the pre-assembled position is located in a portion of the opening facing the head of the fitting screw. The narrowing element in the pre-assembled position is associated with the rim element such that the supporting ring is rotatably and captively connected to the fitting screw. The rim element in the pre-assembled position is located inside of the opening.

The close-tolerance connection unit may also be called a dowel unit or a fitting unit. It is to be understood as a unit including a fitting screw or a close-tolerance screw including a fitting portion or a close-tolerance portion of exact dimensions which serves to provide a centering function to the component to which the unit is to be connected.

Fitting screws or close-tolerance screws include a shank having a fitting portion and a threaded portion. The fitting portion has a diameter which is more than the outer diameter of the threaded portion. The fitting portion serves to position the fitting screw in the component with more exactness than it is the case with normal screws not including a fitting section.

With the novel close-tolerance connection unit, the fitting screw and the supporting ring may be separately produced, and they may be pre-assembled in a captive way, meaning without the danger of the supporting ring being unintentionally detached from the screw. It is possible to use the fitting portion of the fitting screw for its fitting function in the pre-assembled condition of the novel connection unit since at least portions of the fitting portion are not covered by the supporting ring.

The present invention is based on the concept of designing the shank of the fitting screw to include a rim element and the supporting ring to include an associated narrowing element. The narrowing element, contraction or throat of the supporting ring is associated with the rim element of the fitting screw in an overlapping arrangement. The rim element being located at the fitting screw and the narrowing element being located at the supporting ring are designed and arranged such that the supporting ring after having it assembled to the fitting screw is rotatably and captively connected to the screw. The rim element of the shank of the fitting screw is positioned such that it is located inside of the opening of the supporting ring in the pre-assembled position, and that the narrowing element in the opening of the supporting ring is located in a portion of the fitting screw facing the head of the screw. The rim element or the collar, edge, verge or margin and the narrowing element with respect to their overlap are designed such that the fitting screw and the supporting ring may be pre-assembled under elastic-plastic deformation of the rim element and/or of the narrowing element. Not only the narrowing element of the supporting ring, but also the protruding edge being located at the shank of the fitting screw are located in such a region that the edge is located inside of the axial extension of the supporting ring in the pre-assembled position of the novel unit. Consequently, the rim element cannot be seen from the outside after pre-assembly of the rim element and the supporting ring. The same applies to the mounted position of the close-tolerance connection unit at the component. In this way, the portion of the shank not being covered by the supporting ring is free from contact to the rim element, and it may be used to fulfill the function of a fitting portion. Thus, it is possible to realize the fitting portion at this place to achieve the desired centering function between the axis of the fitting screw and the component.

The fitting screw, on the one hand, and the supporting ring, on the other hand, may each be separately produced. They may be produced from different materials, and they may also include different coatings. It is only necessary to assemble the two components during pre-assembly. Pre-assembly is realized by an axial movement of the screw and the ring with respect to one another. It is not necessary to conduct calking. During pre-assembly, plastic deformation following elastic deformation occurring between the rim element and the narrowing element is used to securely connect the supporting ring to the screw to be unrotatable and captive. Comparatively low forces for removing the ring from the screw (as they occur during use of pure elastic deformation) resulting in unintentional detachment of the elements are not sufficient during elastic-plastic deformation. In this way, it is ensured that the pre-assembled position of the close-tolerance connection element is reliably maintained until the unit is used during the actual assembly, meaning during screwing the fitting screw into a component.

The novel unit may also fulfill a double centering effect meaning a first one between the fitting portion at the shank of the screw and the component and a second one between the supporting ring and the fitting screw. This results from the fact that the rim element is located inside of the supporting ring in the pre-assembled position and also in the mounted position.

The rim element being located at the fitting screw and the narrowing element being located in the opening of the supporting ring do not necessarily have to cover 360°, meaning they do not have to be continuous. The rim element and the narrowing element may also include openings as seen along the circumference. However, to effectively use elastic-plastic deformation, the rim element and the narrowing element have to cover a substantial portion of the length of the circumference.

The novel close-tolerance connection unit includes a supporting ring having an opening the diameter of which is more than the diameter of the shank and of the threaded portion of the fitting screw. The diameter of the opening of the supporting ring is also more than the diameter of the rim element being located at the shank of the fitting screw or other protrusions being possibly located at the shank of the fitting screw. In this way, the supporting ring may be pushed upon the shank of the fitting screw in an axial direction. The rim element being located at the fitting screw and the narrowing element being located at the supporting ring contact one another in an axial direction. Taking respective tolerances into account, there is a force threshold to be overcome which results in elastic-plastic deformation in the region of the rim element and/or of the narrowing element. Usually, the rim element and the narrowing element will be elastic-plastically deformed. Each plastic deformation always follows an elastic deformation, meaning there is no plastic deformation without first elastic deformation occurring.

The narrowing element being located in the opening of the supporting ring is located at an axial distance with respect to the end of the fitting screw facing away from the head of the screw. The narrowing element of the opening is not located at the lower end of the supporting ring, but at least at such a distance with respect to this lower end such that the rim element of the fitting screw in the pre-assembled position may be located in the opening of the supporting ring. It is especially preferred when the narrowing element of the opening of the supporting ring is located in the end portion of the supporting ring facing the fitting screw, meaning the upper end. This also provides for the advantage of making it possible to produce the narrowing element at the opening by cold deformation in a very simple way. It is also possible to arrange the narrowing element in the center portion of the axial height of the supporting ring. Such designs may also be produced by turning on a lathe. They provide for improved centering function between the supporting ring and the axis of the fitting screw when the supporting ring contacts the supporting surface of the head, as this is the case in the mounted position of the connection unit at the component.

The rim element at the shank of the fitting screw is located at an axial distance with respect to the head of the screw which is less than the axial height of the supporting ring. In this way, it is ensured that the rim element at the shank of the fitting screw in the mounted position is located within the axial extension of the supporting ring, meaning the rim element is located inside of the supporting ring. Anyway, it is possible to realize sufficient movability between the fitting screw and the supporting ring in an axial direction in the pre-assembled position.

In an especially preferred exemplary embodiment of the novel unit, the rim element being located at the shank to protrude in a radial outward direction is designed and arranged to protrude about 360° of the circumference, meaning it is continuous. The narrowing element being located in the opening of the supporting ring may also be located to be continuous about 360°. In this way, elastic-plastic deformation occurs in a uniform manner about the circumference. There is a good centering function occurring between the fitting screw and the supporting ring during pre-assembly.

In the novel close-tolerance connection unit, the portion of the shank of the fitting screw which is not covered by the supporting ring in the mounted position may be fully used to arrange a fitting portion. The fitting screw includes a fitting portion being located at its shank. The length of the fitting portion may be more than the axial height of the supporting ring. A fitting portion or a close-tolerance portion is to be understood as a portion which has been produced at great exactness and within predetermined tolerances. Preferably, this is a cylindrical portion of the shank of the fitting screw serving to provide a centering function between the axis of the fitting screw and the component. For example, the opening in the component or at least a section in an opening in the component through which the fitting screw extends is coordinated with the diameter of the fitting portion such that the mounted fitting screw reaches its exact position at the component. In this way, it is possible to realize a centering function between a plurality of parts of the component.

To simplify the centering function and pre-assembly of the fitting screw and the supporting ring, the rim element and/or the narrowing element may be designed to include conical surface portions. In this way, there will be an automatic centering function between the fitting screw and the supporting ring during pre-assembly. Elastic-plastic deformation is simplified, and overcoming a force threshold for plastic deformation is very easy. Usually, the conical surface portions are designed to have a truncated conical design.

It is also possible to arrange two or more rim elements at the shank of the fitting screw and/or two or more narrowing elements in the opening of the supporting ring. The rim elements on the one hand, and the narrowing elements on the other hand, may also be located at different diameters to only once plastically deform each rim element with its associated narrowing element. In this exemplary embodiment, there is an increased centering effect between the fitting screw and the supporting ring. This does not only simplify assembly by robots, but it also makes sure that pre-tension of the fitting screw in the mounted position is uniformly transmitted by the supporting ring. Another advantage of this exemplary embodiment is that radial forces may be directly introduced into the shank of the fitting screw by the supporting ring.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first exemplary embodiment of the novel fitting screw being part of the novel close-tolerance connection unit.

FIG. 2 is a sectional view of a part of the novel close-tolerance connection unit including a fitting screw and a supporting ring.

FIG. 3 is an enlarged view of a detail in a region between the fitting screw and the supporting ring.

FIG. 4 is a side view of another exemplary embodiment of the fitting screw.

FIG. 5 is a sectional view of a part of the novel close-tolerance connection unit with the fitting screw FIG. 4.

FIG. 6 is a sectional view of a part of another exemplary embodiment of the novel close-tolerance connection unit including a fitting screw and a supporting ring is a view.

FIG. 7 is a detailed view of FIG. 6 at an enlarged scale.

### DETAILED DESCRIPTION

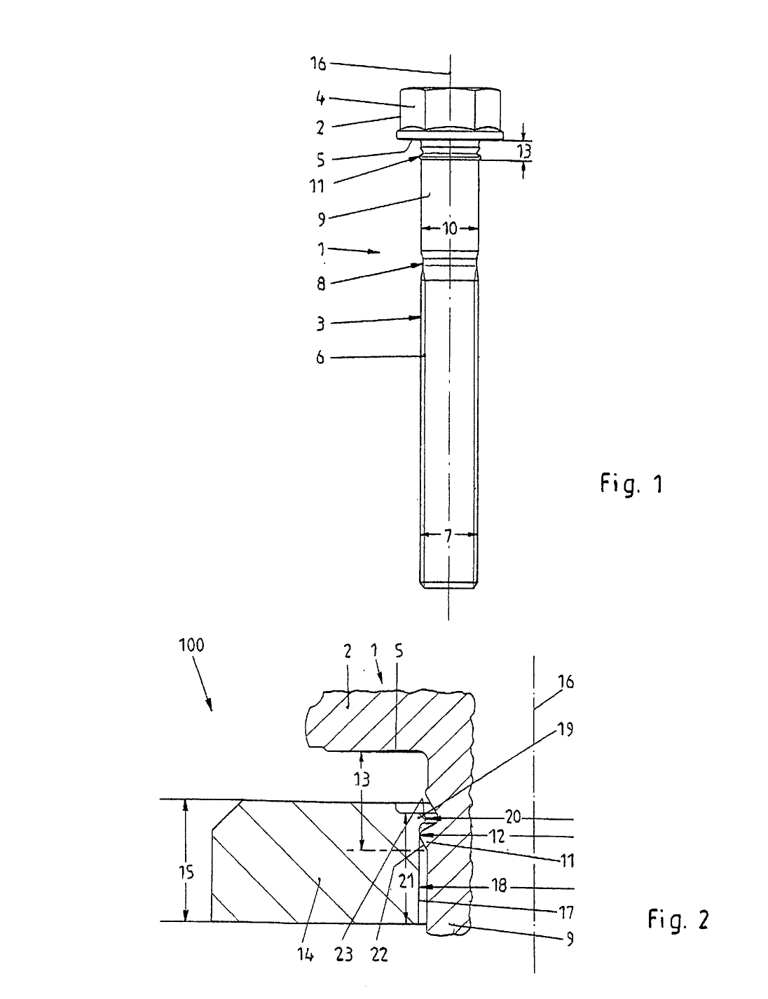

Referring now in greater detail to the drawings, FIG. 1 illustrates a fitting screw 1 or a close-tolerance screw or bolt. The screw 1 includes a head 2 and a shank 3. The head 2 includes an engagement surface 4 for contact to a tool and a supporting surface 5 serving to transmit an axial force. The shank 3 is designed as a longitudinal body having approximately cylindrical shape. It includes a threaded portion 6 which may, for example, be located at its free end facing away from the head 2. The threaded portion 6 has an outer diameter 7. The threaded portion 6 ends at a transition 8. The shank 3 close to the transition 8 is connected to a close-tolerance section 9 having a diameter 10. The diameter 10 is more than the outer diameter 7 of the threaded portion 6. A rim element 11 is arranged in the region of the close-tolerance section 9, it is designed to protrude towards the outside in a radial direction, and it has a diameter 12 (FIG. 2). The rim element or edge 11 with its portion facing the free end of the shank 3 is located at a distance 13 from the supporting surface 5 of the head 2 of the screw 1. The rim element 11 may be designed as a protruding swelling element. The rim element 11 may be produced to extend about the screw 1 by 360°. For example, it may be cold-worked by rolling.

FIG. 2 shows the material as displaced when shaping the rim element 11 from the material of the close-tolerance section 9. FIG. 2 also shows that a supporting ring 14 is associated with the screw 1. The supporting ring 14 and the screw 1 are important parts of the detachable connection element. The supporting ring 14 is designed as an annular, disc-like body. It has a height 15. The height 15 is more than or it at least equals the distance 13. The supporting ring 14 includes an opening 17 having a diameter 18, the opening 17 being arranged in a coaxial way with respect to a common axis 16 of the screw 1 and the supporting ring 14. The supporting ring 14 in its end portion of the opening 17 facing the head of the screw 1 has a narrowing element 19 having a diameter 20. The diameter 20 is less than the diameter 18 of the opening 17. The diameter 20 of the narrowing element 19 is also less than the diameter 12 of the rim element 11. The difference between the diameters 12 and 20 is designated as overlap. This overlap is chosen such that the screw 1 and the supporting ring 14 may be moved to reach the pre-assembled condition (FIG. 2) only by elastic-plastic deformation occurring in the region of the rim element 11 and/or the narrowing element 19. According to FIG. 2, the narrowing element 19 is located in the upper portion of the supporting ring 14 at a distance 21 from the axial end of the supporting ring 14 facing away from the head 2 of the screw 1. The design and arrangement of the rim element 11, the height 15 of the supporting ring 14 and the narrowing element 19 is such that the rim element 11 is completely located inside the opening 17 when the supporting ring 14 contacts the supporting surface 5. This means that the rim element 11 cannot be seen from the outside in this position.

The exemplary embodiments of the novel connection unit 100 as illustrated in FIGS. 1 and 2 also ensure that the close-tolerance section 9 may correctly fulfill its function at a component (not illustrated). The rim element 11 close to its greatest diameter 12 may include a conical portion 22. The narrowing element 19 close to its smallest diameter 20 may include a conical portion 23. The portions 22 and 23 serve to simplify pre-assembly of the novel connection unit 100.

The novel connection unit 100 at least includes the screw 1 and the supporting ring 14. These two elements are produced in separate producing steps. During these production steps, they attain their shape and—depending on the requirements—also a surface coating or the like when required. Pre-assembly of these two elements to form the novel connection unit 100 may be realized by moving the supporting ring 14 from the free end of the shank 3 in an axial direction according to the axis 16. Due to the fact that the diameter 20 of the narrowing element 19 is more than the outer diameter 7 of the threaded portion 6 and also more than the diameter 10 of the close-tolerance section 9, this movement may be realized without having to overcome forces until the narrowing element 19 contacts the rim element 11. The pushing movement is then continued under elastic-plastic deformation of the rim element 11 and/or the narrowing element 19. The supporting ring 14 with its narrowing element 19 passes the rim element 11, and it reaches a position as it is illustrated in FIG. 2. This is called the pre-assembled position. The novel close-tolerance connection element will be transported to its place of use in this condition. For example, it will be used at a conveyor line for the production of automobiles. It will be then connected to a certain component of the automobile, and it will be screwed in, the close-tolerance section 9 fulfilling its centering close-tolerance function at the component (not illustrated).

According to a preferred exemplary embodiment of the novel connection unit 100 including the screw 1 and the supporting ring 14 according to FIGS. 1 and 2, the elements may have the following designs: the screw has a shank 3 having a threaded portion 6 of a metrical thread M14×1.5. The outer diameter 7 of the threaded portion 6 is approximately 14.0 mm. The close-tolerance section 9 has a diameter of approximately 14-0.27 mm. The diameter 12 is approximately 14.65-0.1 mm. The diameter 18 is approximately 14.7+0.1 mm. The diameter 20 is approximately 14.4-0.1 mm.

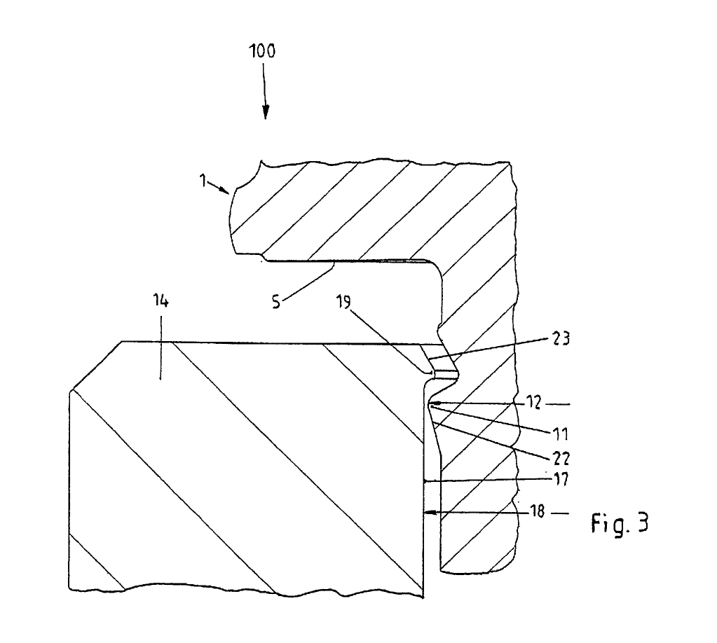

A second exemplary embodiment of the novel connection unit 100 as illustrated in FIG. 3 also includes a screw 1 and a supporting ring 14. In this way, it is referred to the above description. The narrowing element 19 in the opening 17 being located at the supporting ring 14 has not been produced by cold-working, but instead by turning on a lathe of the supporting ring 14 in the region of the opening 17. In this embodiment, the narrowing element 19 is also located in an end portion of the supporting ring 14 which faces the head of the screw 1. With respect to the steps of pre-assembly of the exemplary embodiment of the novel connection element of FIG. 3, it is referred to the above description with respect to FIGS. 1 and 2.

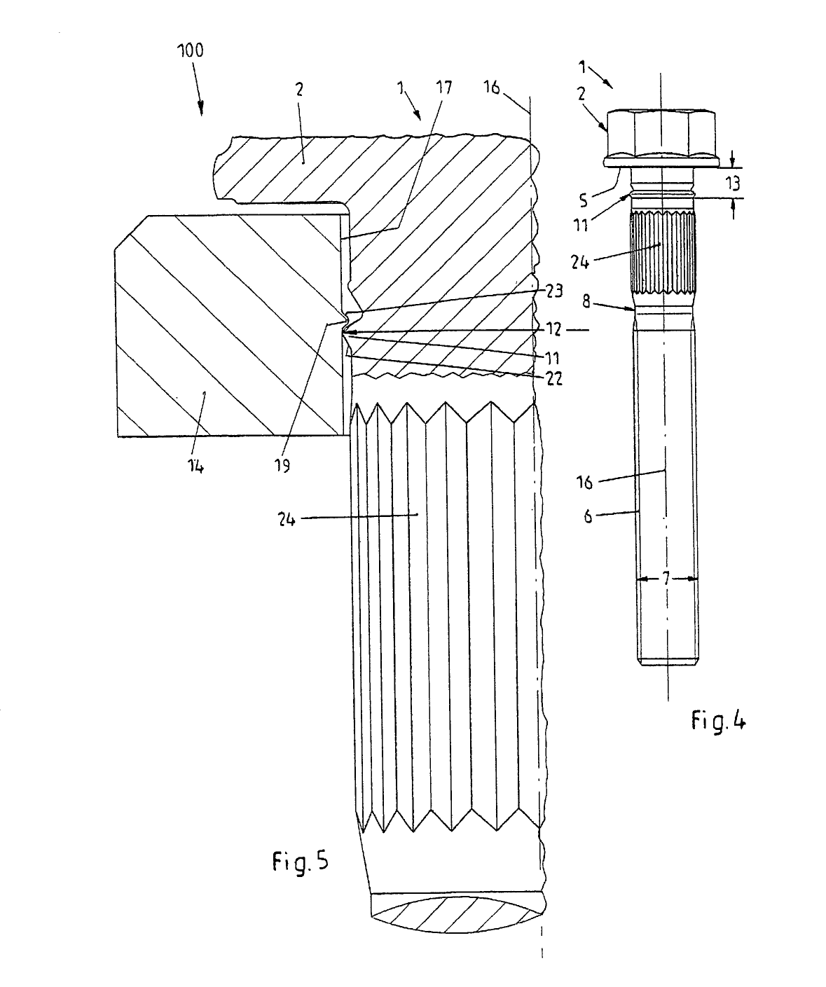

FIGS. 4 and 5 illustrate a third exemplary embodiment of the novel connection unit 100 having a similar design as the above described embodiments. The shank 3 includes a close-tolerance section being located between the threaded portion 6 and the head 2 and being designed as a knurling 24 extending in an axial direction. The narrowing element 19 in the region of the opening 17 is located approximately in a center portion of the axial height of the supporting ring 14. The distance 13 of the rim element 11 with respect to the supporting surface 5 is respectively designed. The proportions of the elements and the distances between the elements have been chosen such that the rim element 11 and the narrowing element 19 are located inside of the supporting ring 14 to be invisible from the outside when the supporting ring 14 contacts the supporting surface 5 as this is the case when the component has been assembled. Consequently, the knurling 24 being located at the portion of the shank 3 protruding outside of the supporting ring 14 can fulfill its function.

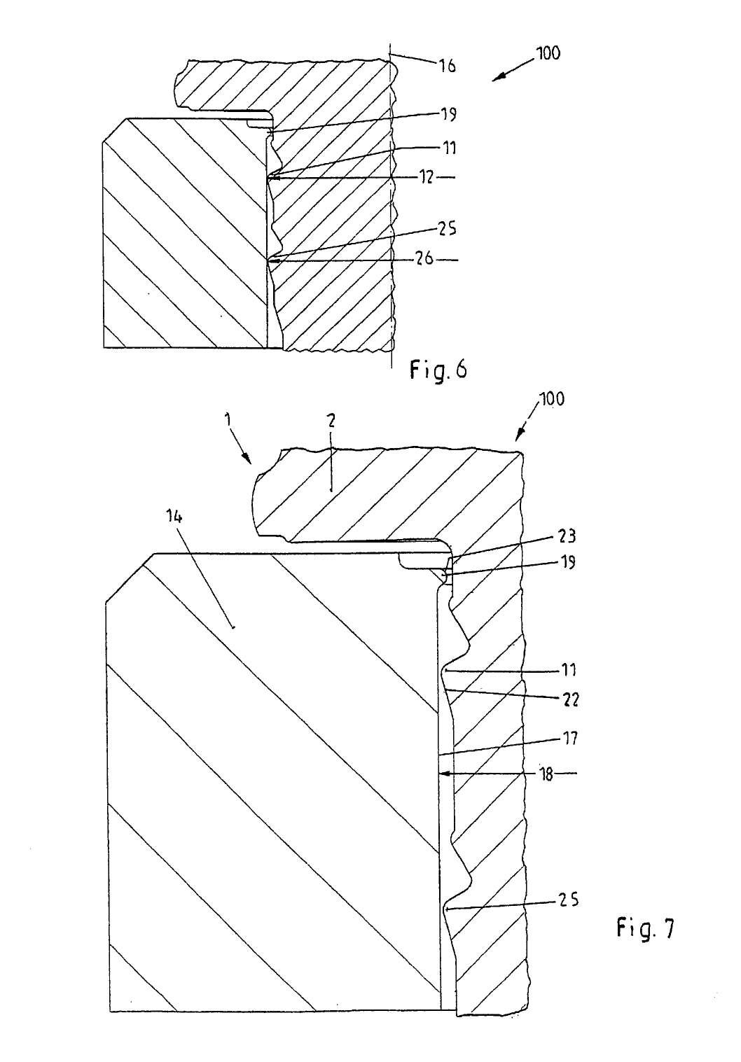

FIGS. 6-7 illustrate another exemplary embodiment of the novel connection unit 100. This exemplary embodiment is similar to the ones described above, but the screw 1 in addition to the rim element 11 includes a second rim element 25 having a diameter 26. The diameters 12 and 26 may have the same design. However, it is also possible to chose the diameter 12 to be slightly more than the diameter 26. In all cases, this is coordinated with the diameter 20 of the narrowing element 19. It is also possible to further increase the number of rim elements 11 and 25. It is also possible to use a plurality of narrowing elements 19 in an axial direction and being associated with the supporting ring 14 in a spaced apart manner about the height 15 of the supporting ring 14. It is preferred to chose the design and structure such that only the associated pair of a rim element and a narrowing element contacts during pre-assembly. The exemplary embodiment of FIGS. 6-7 has the advantage of providing good centering effects between the supporting ring 14 and the screw 1 in its pre-assembled condition. In combination with a close-tolerance section (not illustrated), there may be another centering function occurring between the close-tolerance screw 1 and the component.

In all above described exemplary embodiments of the novel connection unit 100, there is a variety of possibilities for realizing the rim elements 11, 25 and the narrowing element 19. A preferred exemplary embodiment of the novel connection unit 100 includes a swelling portion extending over the circumference by 360° and having a constant cross section. This preferred design results in uniform elastic-plastic deformation. However, it is also possible to design the rim element 11 and the narrowing element 19 to be locally broken, meaning to include recesses about the circumference.

Many variations and modifications may be made to the preferred embodiments of the invention without departing substantially from the spirit and principles of the invention. All such modifications and variations are intended to be included herein within the scope of the present invention, as defined by the following claims.

We claim:

1. A detachable close-tolerance connection unit for a component, comprising:
a fitting screw including a head, a shank, a threaded portion and a fitting portion, said shank including a rim element having an outer diameter; and
a supporting ring including an opening and a narrowing element being located in said opening and having an inner diameter, the inner diameter of said narrowing element being less than the outer diameter of said rim element, said supporting ring being designed and arranged to be connectable to said fitting screw with elastic-plastic deformation to reach a pre-assembled position,
said narrowing element in the pre-assembled position being located in a portion of said opening facing said head of said fitting screw,
said narrowing element in the pre-assembled position being associated with said rim element such that said supporting ring is rotatably and captively connected to said fitting screw, and
said rim element in the pre-assembled position being located inside of said opening.

2. The connection unit of claim 1, wherein said opening has an inner diameter, said shank has an outer diameter and said threaded portion has an outer diameter, the inner diameter of said opening being more than the outer diameter of said shank and the outer diameter of said threaded portion.

3. The connection unit of claim 1, wherein said supporting ring has a first end facing away from said head of said fitting screw, said narrowing element being located at an axial distance with respect to said first end of said supporting ring.

4. The connection unit of claim 2, wherein said supporting ring has a first end facing away from said head of said fitting screw, said narrowing element being located at an axial distance with respect to said first end of said supporting ring.

5. The connection unit of claim 1, wherein said supporting ring has an axial height, said rim element being located at an axial distance with respect to said head of said fitting screw which is less than the axial height of said supporting ring.

6. The connection unit of claim 2, wherein said supporting ring has an axial height, said rim element being located at an axial distance with respect to said head of said fitting screw which is less than the axial height of said supporting ring.

7. The connection unit of claim 3, wherein said supporting ring has an axial height, said rim element being located at an axial distance with respect to said head of said fitting screw which is less than the axial height of said supporting ring.

8. The connection unit of claim 4, wherein said supporting ring has an axial height, said rim element being located at an axial distance with respect to said head of said fitting screw which is less than the axial height of said supporting ring.

9. The connection unit of claim 1, wherein said rim element is designed to extend about 360° of said fitting screw.

10. The connection unit of claim 1, wherein said narrowing element is designed to extend about 360° of said supporting ring.

11. The connection unit of claim 9, wherein said narrowing element is designed to extend about 360° of said supporting ring.

12. The connection unit of claim 1, wherein said wherein said supporting ring has an axial height and said fitting portion has an axial length, the axial length of said fitting portion being more than the axial height of said supporting ring.

13. The connection unit of claim 1, wherein said rim element includes conical surface portions.

14. The connection unit of claim 1, wherein said narrowing element includes conical surface portions.

15. The connection unit of claim 1, wherein said rim element and said narrowing element each include conical surface portions.

16. The connection unit of claim 1, further comprising a second rim element being located at said shank of said fitting screw and a second narrowing element being located at said opening of said supporting ring.

17. The connection unit of claim 1, wherein said rim element is designed to be elastic-plastically deformable.

18. The connection unit of claim 1, wherein said narrowing element is designed to be elastic-plastically deformable.

19. The connection unit of claim 1, wherein said rim element and said narrowing element are each designed to be elastic-plastically deformable.

20. A detachable fitting connection unit, comprising:
a fitting screw including a head, a shank having an outer diameter, a threaded portion having an outer diameter and a fitting portion having an outer diameter, said shank including a rim element having an outer diameter; and
a supporting ring including an opening having an inner diameter and a narrowing element being located in said opening and having an inner diameter, the inner diameter of said opening being more than the outer diameter of said shank and the outer diameter of said threaded portion, the inner diameter of said narrowing element being less than the outer diameter of said rim element, said supporting ring being designed and arranged to be connectable to said fitting screw with elastic-plastic deformation to reach a pre-assembled position,
said narrowing element in the pre-assembled position being located in a portion of said opening facing said head of said fitting screw,
said narrowing element in the pre-assembled position being associated with said rim element such that said supporting ring is rotatably and captively connected to said fitting screw, and
said rim element in the pre-assembled position being located inside of said opening.
